(19) United States
(12) Patent Application Publication
(10) Pub. No.: US 2009/0324975 A1
(43) Pub. Date: Dec. 31, 2009

(54) METAL-RESIN COMPOSITE MEMBER AND MANUFACTURNG METHOD THEREFO

(75) Inventor: Tsunao Kenmochi, Aichi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/489,483

(22) Filed: Jun. 23, 2009

Related U.S. Application Data
(60) Provisional application No. 61/133,307, filed on Jun. 27, 2008.

(51) Int. Cl. B32B 15/088; B32B 15/09; B32B 37/12

(52) U.S. Cl. 428/458; 156/60

(57) ABSTRACT

The present invention provides metal-resin composite member, comprising (a)a metal member having at least one surface; (b) a resin member comprising a thermoplastic resin and a dispersed inorganic material therein; (c)a thermoplastic resin film, deposed between and bonded to said resin member and said metal member, having provided on at least one face thereof an adhesion promoter, so that said at least one face of said resin film provided with said adhesion promoter contacts at least part of said at least one surface of said metal member; wherein said thermoplastic resins of said resin member and said resin film are semicrystalline resins. The present invention further provides a method for manufacturing a metal-resin composite member by bonding a metal member and a resin member by fusing a resin film arranged therebetween said metal member and said resin member; wherein the thermoplastic resins of the rein member and resin film are semicrystalline resins.

### FIELD OF THE INVENTION

The present invention relates to a metal-resin composite member and to a manufacturing method thereof.

### BACKGROUND OF THE INVENTION

In fields such as automobiles, electronic devices, industrial machinery and the like it is common to use components comprising either a metal member or a resin member. That is, metal components or resin components are manufactured and are then ordinarily assembled together.

In recent years, by contrast, composite members in which a metal member and a resin member are bonded together have attracted attention as a means for coping with a wide variety of characteristic requirements as well as in terms of, for instance, weight reduction and cost reduction.

Methods for bonding the metal member and the resin member are broadly divided into physical bonding and chemical bonding. Physical bonding refers to bonding between members affected by means of irregularities and mating portions formed on the metal member and the resin member. Packing is often sandwiched between the metal and the resin component in order to secure adherence.

In chemical bonding, the metal member and the resin member are bonded by way of interactions between the members. The most ordinary chemical bonding method involves using an adhesive agent. For instance, hot melt adhesives and epoxy thermosetting resins are often used. However hot melt adhesives generally have poor thermal stability and epoxy and other thermosetting resins require long set times to establish the maximum adhesive bond. Other known methods involve irradiating laser light onto the bonding portion, to fuse the bonding portion and elicit bonding through compression bonding, or methods that involve providing a layer comprising a thermoplastic resin or a thermosetting resin between members of dissimilar materials, and then elicit bonding via such a resin layer through heating and application of pressure. Also known in the prior art are the below-described insert molding methods.

Japanese Unexamined Patent Application Laid-open No. 2006-315398 describes a method for obtaining a metal-resin composite member by insert injection molding in which a metal member is inserted into a mold and a resin composition is injected, to be bonded with the metal member. Such a method for obtaining a metal-resin composite member comprises, specifically, carrying out insert injection molding by inserting into an injection mold an aluminum-alloy shaped article having been immersed in an aqueous solution selected from among ammonia, hydrazine and a water-soluble amine compound, and injecting a polyamide resin to elicit bonding with the aluminum-alloy shaped article.

Japanese Unexamined Patent Application Laid-open No. 2007-50630 describes also a method for obtaining a metal-resin composite member by insert injection molding in which a metal member is inserted into a mold and a resin composition is injected to be bonded with the metal member. Specifically disclosed is a composite member comprising a metal member the entire surface whereof is covered by recesses having an average inner diameter no greater than 80 nm, and a resin member comprising 70 to 99wt % of polyphenylene sulfide and 1 to 30wt % of a polyolefin resin.

Meanwhile, adhesion promoters including silane coupling agents are known as bonding enhancing agents that are disposed between members. For instance, Japanese Unexamined Patent Application Laid-open Nos. S61-154135 and H07-329104 disclose a method for improving adherence by coating lead wires beforehand with a silane coupling agent, followed by resin encapsulation. Also, Japanese Unexamined Patent Application Laid-open No. 2003-103562 discloses a technology to the effect of treating a surface with an alkaline or acid solution prior to carrying out a silane coupling agent treatment.

Although using a silane coupling agent allows increasing bonding strength between a metal member and a resin member, conventional methods are problematic, in commercial terms, in that they entail poor productivity. That is, although there have been proposed methods for coating the surface of a metal member with a silane coupling agent, any operation in which a solution is employed is apt to impair productivity and reliability (bonding strength). During partial bonding of members, for instance, the application of the solution is required to be rigorously controlled to avoid bonding of areas that are not be bonded, on account of solution dripping, while control of raw materials and processes tends also to be complex in such methods.

Needed are methods for forming composite members that give fast reliable bonding with a minimum of curing time, and high thermal stability.

One object of the present invention is to provide a method for bonding a metal member and a resin member, excellent in productivity and reliability.

### SUMMARY OF THE INVENTION

One aspect of the invention is a metal-resin composite member, comprising
a) a metal member having at least one surface;
b) a resin member comprising a thermoplastic resin and a dispersed inorganic material therein;
c) a thermoplastic resin film, deposed between and bonded to said resin member and said metal member, having provided on at least one face thereof an adhesion promoter, so that said at least one face of said resin film provided with said adhesion promoter contacts at least part of said at least one surface of said metal member;
   wherein said thermoplastic resins of said resin member and said resin film are semicrystalline resins having a melt temperature; are selected from a resin class selected from the group consisting of polyamides, polyesters, copolyetheramide elastomers, copolyetherester elastomers, and blends thereof; and are chosen from either the same resin class or, if said thermoplastic resin of said resin member and said resin film are selected from different resin classes, said melt temperature of said resin of said resin film is equal to or lower than that of said resin of said resin member.

Another aspect of the invention is method for manufacturing a metal-resin composite member, comprising the steps of:

arranging at least one surface of a metal member so as to oppose at least one surface of a resin member comprising a thermoplastic resin and a dispersed inorganic material therein;

arranging therebetween a thermoplastic resin film having provided on at least one face thereof an adhesion promoter, so that said face provided with said adhesion promoter contacts at least part of said least one surface of the metal member; and

bonding said metal member and said resin member by fusing said resin film thereto;

wherein said thermoplastic resins of said resin member and said resin film are semicrystalline resins having a melt temperature; are selected from a resin class selected from the group consisting of polyamides, polyesters, copolyetheramide elastomers, copolyetherester elastomers, and blends thereof; and are chosen from either the same resin class or, if said thermoplastic resin of said resin member and said resin film are selected from different resin classes, said melt temperature of said resin of said resin film is equal to or lower than that of said resin of said resin member

### BRIEF DESCRIPTION OF THE DRAWINGS

FIG. 1 illustrates the formation of a metal-resin composite of the invention.

FIG. 2 illustrates the procedure for measuring bonding strength of the metal-resin composite members.

### DETAILED DESCRIPTION OF THE INVENTION

The metal member having at least one surface. used in the metal-resin composite member of the present invention, is not particularly limited provided that it is a metal or a metal alloy. Examples thereof include, for instance, steel, nickel, chromium, copper, zinc, titanium, aluminum, magnesium or the like, or metal alloys of the foregoing. Preferably, each said at least one surface of said metal member is independently selected from the group consisting of aluminum, aluminum alloy, iron and iron alloy.

The thermoplastic resins of the resin member and resin film are semicrystalline resins having a melt temperature. The melt temperature of the resin is determined by differential scanning calorimetry using ISO method 11357-1/-3, or equivalent procedure. Thermoplastic resins of the resin member and resin film are selected from a resin class selected from the group consisting of polyamides; polyesters; copolyetheramide elastomers; copolyetherester elastomers; and blends thereof. The term “blends thereof” includes blends of two or more resins from the same resin class and blends of two or more resins from different resin classes. The resin blends include miscible blends, and immiscible blends including a continuous and a discontinuous phase.

Preferably, the thermoplastic resins of the resin member and the resin film are chosen from the same resin class, and more preferably are the same resin. However, when the thermoplastic resins of the resin member and resin film are selected from different resin classes, the melt temperature of the resin of the resin film is equal to or lower than that of the resin of the resin member. When the thermoplastic resin of the resin film is a miscible blend of resins, at least one melt temperature of the blend of resins is equal or lower than that of the resin of the resin member. When the thermoplastic resin of the resin film is an immiscible blend the continuous phase preferably has a melt temperature equal or than that of the resin of the resin member.

Examples of thermoplastic resins useful as resins for the resin member and resin film include, for instance, polyamides (PA) polyethylene (PE), polypropylene (PP), styrene-acrylonitrile copolymers, polyesters, polycarbonate (PC), and the like.

Preferably the thermoplastic resins are selected from a resin class selected from the group consisting of polyamides including polyamide 6, polyamide 6,6, polyamide 6,10, polyamide 6,12, polyamide 66,6T, polyamide 6T,DT, and blends thereof; polyesters (including poly(ethylene) terephthalate (PET), poly(trimehtylene) terephthalate (PTT); poly(butylene) terephthalate) (PBT) and blends thereof; copolyetheramide elastomers and blends thereof; and copolyetherester elastomers and blends thereof; and are chosen from the same resin class; or, if the thermoplastic resin of the resin member and resin film are selected from different resin classes, the melt temperature of the resin of the resin film is equal to or lower than that of the resin of the resin member.

The polybutylene terephthalate (PBT) resin may be a homopolymer obtained by condensation polymerization of terephthalic acid and butanediol, but may also be copolymer containing other comonomer components that share the physical and chemical characteristics of polybutylene terephthalate resins. Examples of these other comonomer components include, for instance, glycol components such as ethylene glycol, 1,2-polypropylene glycol, pentanediol, hexanediol, 1,4-cyclohexanedimethanol or the like, or dicarboxylic acid components such as isophthalic acid, naphthalene dicarboxylic acid or the like. Specific examples of the above copolymers include, for instance, (poly)butylene-coethylene-terephthalate, (poly)butylene-co-1,4-cyclohexanedimethylene-terephthalate, (poly)butylene-copentylene-terephthalate, (poly)butylene-cohexylene-terephthalate, (poly)butylene-terephthalate-isophthalate, (poly)butylene-terephthalate-naphthalene dicarboxylate and the like. The polybutylene terephthalate resin used in the present invention is preferably a polybutylene terephthalate resin having an intrinsic viscosity of at least about 0.4 when measured in a 0.1% m-cresol solution at 30° C., more preferably a polybutylene terephthalate resin having an intrinsic viscosity of up to about 1.2.

The copolyetheramide elastomer useful in this invention is an elastomer composed of a polymeric hard segment (X) which is a poly(aminocarboxylic acid) or poly(lactam) having 6 or more carbon atoms or a nylon m,n polymer in which m+n is 12 or more and a polymeric soft segment (Y) which is a polyol, specifically a poly(alkylene oxide)glycol, wherein the proportion of the (X) component is 10-95% by weight, preferably 20-90% by weight.

The polymeric hard (X) segment include poly(aminocarboxylic acids) such as ω-aminocaproic acid, ω-aminoenanthic acid, ω-aminocaprylic acid, ω-aminopelargonic acid, ω-aminocapric acid, 11-aminoundecanoic acid, 12-aminododecanoic acid and the like; lactams such as caprolactam, laurolactam and the like; and nylons such as nylon 6,6, nylon 6,10, nylon 6,12, nylon 11,6, nylon 11,10, nylon 12,6, nylon 11,12, nylon 12,10, nylon 12,12 and the like.

The (Y) segment, is one or more poly(alkylene oxide)glycols, as described above, and include poly(ethylene oxide)glycol, poly(1,2-or 1,3-propylene oxide)glycol, poly(tetramethylene oxide)glycol, poly(hexamethylene oxide)glycol, an ethylene oxide-propylene oxide block or random copolymer, an ethylene oxide-tetrahydrofuran block or random copolymer, etc. Of these poly(alkylene oxide)glycols (Y), poly(ethylene oxide)glycol is particularly preferable because of its compatibility with polyoxymethylene. The number-average molecular weight of the poly(alkylene oxide)glycol (Y) is preferably 200-6,000, more preferably 250-4,000.

The terminals of the poly(alkylene oxide)glycol (Y) may be aminated or carboxylated. As the bond between the (X) component and the (Y) component, an ester bond or an amide bond is possible depending upon the terminal groups of the polyamide elastomer. In bonding the (X) component to the (Y) component, a third component (Z) such as a dicarboxylic acid, a diamine or the like can be used.

The dicarboxylic acid is such as to have 4-20 carbon atoms and includes, for example, aromatic dicarboxylic acids such as terephthalic acid, isophthalic acid, naphthalene-2,6-dicarboxylic acid, naphthalene-2,7-dicarboxylic acid, diphenyl-4,4-dicarboxylic acid, diphenoxyethanedicarboxylic acid, sodium 3-sulfoisophthalate and the like; alicyclic dicarboxylic acids such as 1,4-cyclohexanedicarboxylic acid, 1,2-cyclohexanedicarboxylic acid, dicyclohexyl-4,4-dicarboxylic acid and the like; aliphatic dicarboxylic acids such as succinic acid, oxalic acid, adipic acid, sebacic acid, dodecanedicarboxylic acid and the like; and their mixtures. Of these, terephthalic acid, isophthalic acid, 1,4-cyclohexanedicarboxylic acid, sebacic acid, adipic acid and dodecanedicarboxylic acid are particularly preferable in view of polymerizability, color and physical properties.

The diamine includes aromatic, alicyclic and aliphatic diamines. An example of the aliphatic diamines is hexamethylenediamine.

The copolyetherester elastomers useful in the invention are such as is disclosed in U.S. Pat. No. 3,766,146, U.S. Pat. No. 4,014,624 and U.S. Pat. No. 4,725,481. These patents disclose a segmented thermoplastic copolyetherester elastomer containing recurring polymeric long chain ester units derived from carboxylic acids and long chain glycols and short chain ester units derived from dicarboxylic acids and low molecular weight diols. The long chain ester units form the soft segment of the copolyetherester elastomer, and the short chain ester units form the hard segment.

More specifically, such copolyetherester elastomers may comprise a multiplicity of recurring intralinear long chain and short chain ester units connected head-to-tail through ester linkages, said long chain ester units being represented by the formula:

—OGO—C(O)AC(O)— (I)

and said short-chain ester units being represented by the formula:

—ODO—C(O)AC(O)— (II)

wherein:
G is a divalent radical remaining after removal of terminal hydroxyl groups from poly(alkylene oxide) glycols, as disclosed above, having a carbon to oxygen ratio of about 2.0-4.3, a molecular weight above about 400 and a melting point below about 60° C.;
A is a divalent radical remaining after removal of carboxyl groups from a dicarboxylic acid having a molecular weight less than about 300; and
D is a divalent radical remaining after removal of hydroxyl groups from a low molecular weight diol having a molecular weight less than about 250.
It is preferred that the short chain ester units constitute about 15-95% by weight of the copolyester and at least about 50% of the short chain ester units be identical.

The term “long chain ester units” as applied to units in a polymer chain refers to the reaction product of long chain glycol with a dicarboxylic acid. Such “long chain ester units”, which are a repeating unit in the copolyesters, correspond to the formula (I) above. The long chain glycols are polymeric glycols having terminal (or as nearly terminal as possible) hydroxyl groups and a molecular weight above about 400 and preferably from about 400-4000. The long chain glycols used to prepare the copolyesters are poly(alkylene oxide) glycols as disclosed above.

The term “short chain ester units” as applied to units in a polymer chain refers to low molecular weight compounds or polymer chain units having molecular weights less than about 550. They are made by treating a low molecular weight diol (below about 250) with a dicarboxylic acid to form ester units represented by formula (II) above.

Included among the low molecular weight diols which react to form short chain ester units are acyclic, alicyclic and aromatic dihydroxyl compounds, an example of which is 1,4-butanediol. Dicarboxylic acids which are reacted with the foregoing long chain glycols and low molecular weight diols to produce the copolyesters of this invention are aliphatic, cycloaliphatic or aromatic dicarboxylic acids of low molecular weight, that is, having a molecular weight of less than about 300, an example of which is terephthalic acid.

In one embodiment useful copolyetheresters useful for the resin film have a flexural modulus between 150 MPa and 1500 MPa at room temperature and can be obtained by varying the ratio of hard to soft segments, or by using different molar weights of alkylene oxide and soft segments. Examples of specific copolyetherester elastomers useful in the invention are the Hytrel® elastomers available from E.I. du Pont de Nemours and Company, Wilmington, Del.; RITEFLEX® elastomers available from Ticona; and ARNITEL® elastomers available from DSM.

One embodiment is a composite member wherein the thermoplastic resins of the resin member and resin film are polyamides.

One embodiment is a composite member wherein the thermoplastic resin of the resin member is a polyamide and the thermoplastic film is a polyetherester.

One embodiment is a composite member wherein the thermoplastic resin of the resin member is a polyester and the thermoplastic film is a polyetherester. A resin layer formed of the above polyester elastomer is preferably used when employing polybutylene terephthalate (PBT) as the matrix resin of the resin member.

The thermoplastic resin film used in forming the composite member has a thickness of 10 to 200 μm, more preferably 15 to 150 μm, and most preferably 50 to 100 μm. The thermoplastic resin film has provided on at least one face thereof an adhesion promoter, so that the face of the resin film provided with the adhesion promoter contacts at least part of at least one surface of the metal member.

The adhesion promoter is useful in improving the bonding of the thermoplastic resin film to the metal member. In one embodiment the thermoplastic resin film comprises an adhesion promoter fraction of about 0.01 to about 4 wt %, and preferably about 0.1 to about 2.0 wt %, based on the total weight of the thermoplastic resin film. Adhesion promoters useful in the embodiments of the invention are selected from the group consisting of metal hydroxides and alkoxides; and silicate hydroxides and alkoxides; and combinations thereof.

Metal hydroxides and alkoxides useful as adhesion promoters include those of Group IIIa thru VIIIa, Ib, IIb, IIIb, and IVb of the Periodic Table and the lanthanides. Specific adhesion promoters are metal hydroxides and alkoxides of metals selected from the group consisting of Ti, Zr, Mn, Fe, Co, Ni, Cu, Zn, Al, and B. Preferred metal hydroxides and alkoxides are those of Ti and Zr. Specific metal alkoxide adhesion promoters are titanate and zirconate orthoesters and chelates including compounds of the formula (I), (II) and (III):

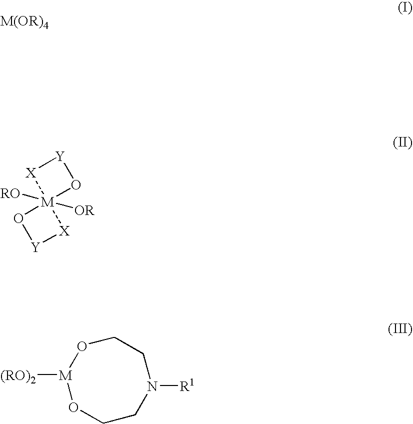

wherein

M is Ti or Zr;

R is a monovalent C₁-C₈ linear or branched alkyl;

Y is a divalent radical selected from —CH(CH₃)—, —C(CH₃)═CH₂—, or —CH₂CH₂—;

X is selected from OH, —N(R¹)₂, —C(O)OR³, —C(O)R³, —CO₂⁻A⁺; wherein

R¹ is a —CH₃ or C₂-C₄ linear or branched alkyl, optionally substituted with a hydroxyl or interrupted with an ether oxygen; provided that no more than one heteroatom is bonded to any one carbon atom;

R³ is C₁-C₄ linear or branched alkyl;

A⁺ is selected from NH₄⁺, Li⁺, Na⁺, or K⁺.

Commercially available titanate and zirconate orthoesters and chelates useful as adhesion promoters are the TYZOR® organic titanates and zirconates available from E.I. DuPont de Nemours, Inc., Wilmington, Del. Specific organic zirconates are TYZOR® 212, 217, TEAZ, and CI-24 organic zirconates. Specific organic titanates are TYZOR® TE and LA organic titanates.

Silicate hydroxides and alkoxy silanes useful as adhesion promoters include those of formula (IV)

(R¹¹O)₄₋ₘSi(R¹²)ₘ

wherein

m is an integer equal to 0, 1, 2, or 3;

R¹¹ is hydrogen or a C₁-C₆ linear or branched alkyl; and

R¹² is a C₁-C₁₂ linear or branched alkyl, optionally having 1 or 2 carbon carbon double bonds, and optionally substituted by —NH₂; —CN, —NCO, glycidyl ether, or —OC(O)—CR¹³═CH₂; wherein R¹³ is hydrogen or C₁-C₄ alkyl. Specific examples of alkoxy silanes useful in the invention are tetramethoxysilane; tetraethoxysilane, tetrapropoxysilane, tetrabutoxysilane, trimethoxymethylsilane, triethoxymethylsilane, trimethoxyvinylsilane, triethoxyvinylsilane, 3-aminopropyl trimethoxysilane, 3-aminopropyl triethoxysilane, 3-methacryloyloxypropyl trimethoxysilane, 3-methacryloyloxypropyl triethoxysilane, 3-lycidoxypropyltrimethoxysilane, glycidoxypropyltriethoxysilane, glycidoxypropylmethyidimethoxysilane, 3-isocyanatopropyl trimethoxysilane, 3-isocyanatopropyl triethoxysilane, and 3-cyanopropyl trimethoxysilane. In one embodiment 3-aminopropyl triethoxysilane is a preferred adhesion promoter. In another embodiment the reaction products of amino silanes and epoxy silanes are a preferred adhesion promoter.

The adhesion promoter is ordinarily applied to the resin layer diluted in water/alcohol (for instance, methanol, ethanol or the like) to an adhesion promoter concentration of 1 to 100 wt %, preferably a 10 to 100 wt % solution. The method for applying the adhesion promoter solution to the resin layer may involve, for instance, spraying the adhesion promoter solution onto the resin layer, dipping the resin layer in the adhesion promoter solution, or direct coating onto the resin surface. The adhesion promoter may also be provided on both faces of the resin layer.

The inorganic material dispersed in the resin of the resin member is not limited to a specific inorganic material, and may be, for instance, a silicate such as anhydrous silicic acid, hydrous silicic acid, hydrous calcium silicate, hydrous magnesium silicate, hydrous aluminum silicate or the like, as well as a composite of such silicates or a modified silicate of the foregoing having been subjected to a surface treatment; as well as calcium carbonate, magnesium carbonate, talc, clay, wollastonite, kaolin, mica, asbestos, feldspar, potassium titanate, whisker, glass fibers, carbon fibers, rock wool or the like. Preferred inorganic materials are glass fibers, carbon fibers and the like. The content of inorganic material in the matrix resin is preferably 5 to 60 wt %, and more preferably 10 to 45 wt %. The most preferred inorganic material is sized glass fiber. The term “sized glass fiber” refers to the conventional practice, usually performed by the glass manufacturer, of treating the glass fiber after spinning with a film forming agent and a bonding agent to improve the flowability of the fiber bundles in feed hoppers, and improve the wetting and bonding of the glass to the resin matrix. These treatments are often proprietary for each glass product, but generally are well known in the art, for instance, as disclosed in GB Pat 1,456,628.

In one embodiment the composite member has a bonding strength between said metal member and said resin member of at least 300 Newtons, and preferably greater than 1000 Newtons, as measured with the method of measuring bonding strength, disclosed herein, herein referred to as the Method of Measuring Bonding Strength, at room temperature (about 23° C.) with a bonding area of about 450 mm².

Another embodiment is a composite member as disclosed above wherein at least 90 % of the adhesive strength between said metal member and said resin member is present within 48 hours of bonding the components (a), (b) and (c).

Another embodiment of the invention is a method for manufacturing a metal-resin composite member, comprising the steps of:

arranging at least one surface of a metal member so as to oppose at least one surface of a resin member comprising a thermoplastic resin and a dispersed inorganic material therein;

arranging therebetween a thermoplastic resin film having provided on at least one face thereof an adhesion promoter, so that said face provided with said adhesion promoter contacts at least part of said least one surface of the metal member; and

bonding said metal member and said resin member by fusing said resin film thereto;

wherein said thermoplastic resins of said resin member and said resin film are semicrystalline resins having a melt temperature; are selected from a resin class selected from the group consisting of polyamides, polyesters, copolyetheramide elastomers, copolyetherester elastomers, and blends thereof; and are chosen from either the same resin class or, if said thermoplastic resin of said resin member and said resin film are selected from different resin classes, said melt temperature of said resin of said resin film is equal to or lower than that of said resin of said resin member.

The metal member, resin member, resin film, and adhesion promoter useful in this method are those as described above.

Bonding can be accomplished by any conventional fusion method for fusing the above resin film. Examples thereof include, for instance, fusion by hot-plate heating, fusion by high-frequency induction heating, laser fusion, injection fusion, ultrasound fusion, vibration fusion, spin fusion and the like. Preferred fusion methods include fusion by hot-plate heating, fusion by high-frequency induction heating and laser fusion. In laser fusion, preferably, a laser absorbent is placed on the surface of the metal member, in contact with the resin film, or in contact with the resin member. Examples of the laser absorbent include, for instance, carbon black and coloring materials such as dyes and pigments, preferably carbon black.

The metal-resin composite members formed by the process of the invention include automobile engine parts such as oil pans, rocker covers, chain covers and other components that come in contact with hot oil,

### EXAMPLES

Method for Molding the Resin Member

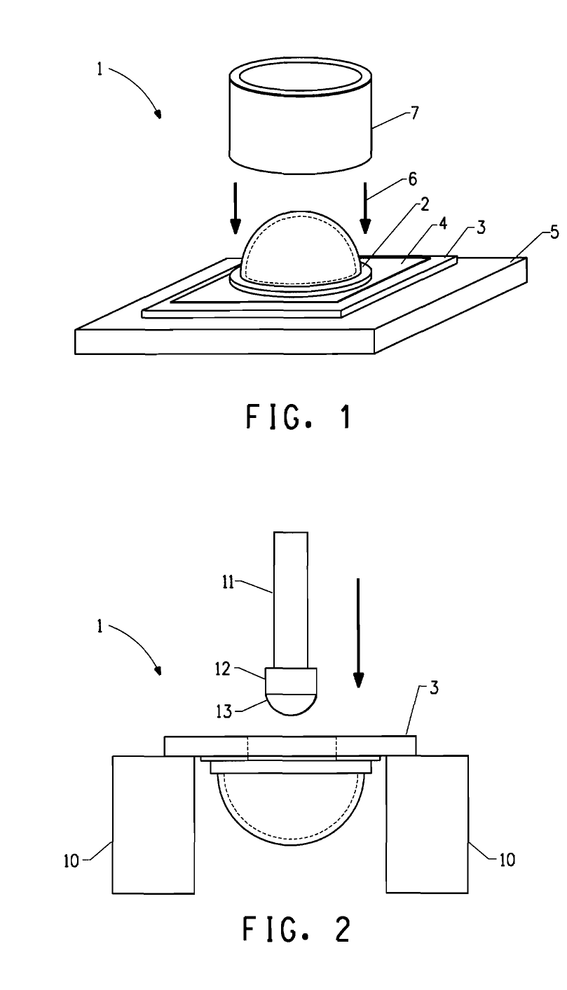

A resin member (2) in the shape of a hollow hemisphere (36 mm outer diameter; 32 mm inner diameter) having a circular flange (2 mm thick) extending from the base of the hemisphere (40 mm diameter), illustrated in FIG. 1; was prepared by drying at 70° C. for 5 hours or more a polyamide 6,6 resin (Zytel® 70G33HS1L NC010, from E.I. du Pont de Nemours and Company, Wilmington, Del.) reinforced with 33% glass fibers, and by injection-molding of the resin, with a water content not exceeding 0.2%, using a universal injection molding machine (α100iA, by Fanuc), at a resin temperature of 290° C. and a mold temperature of 90° C.

A second resin member (2) having the shape as described above, was similarly prepared by drying at 120° C. for 5 hours or more a PBT resin (Crastin® SK605 NC010, from E.I. du Pont de Nemours and Company, Wilmington, Del.) reinforced with 30% glass fibers, and by injection-molding the resin, with a water content not exceeding 0.05%, using a universal injection molding machine (α100iA, by Fanuc), at a resin temperature of 260° C. and a mold temperature of 80° C.

Method for Molding a Resin Film

Resin films (45 mm×45 mm×0.015-0.2 mm) were formed using a polyamide 6,6 resin (Zytel E51HSB NC010, by DuPont) or a polyester elastomer (Hytrel® HTR8346 elastomer, from E.I. du Pont de Nemours and Company, Wilmington, Del. by DuPont). One face or both faces of these resin films were subjected to the a silane coupling agent treatment as described below.

Method for Applying the Silane Coupling Agent

A silane coupling agent stock solution (Z6011, from Toray Dow Corning Co., Ltd.) was applied onto the surface of the resin film (one or both faces) using a brush, followed by wiping of excess solution and drying in an oven at 80° C. for one hour.

Method for Forming the Metal-Resin Composite Member

An aluminum die cast metal plate (50 mm×50 mm×2 mm) was prepared having a 25-mm diameter hole in the central portion. The central hole was provided for insertion of a stress-exerting jig for measurement of the bonding strength, and for examining the condition of bonding in the interior of the gap.

FIG. 1 illustrates the formation of a metal composite member (1). The metal member (3), the resin film (4) and the resin member (2) were stacked vertically, in the bonding disposition, on a plate heater (5) residually heated beforehand to 20° C. lower than the melting point of the resin film. The heater was heated next, to a temperature 5° C. higher than the melting point of the resin film. The heater was turned off when the temperature reached a temperature 5° C. higher than the melting point of the resin film, and then a load (6) (0.5 MPa) was applied using a steel tubular thrust ring (7) (outer diameter 40 mm, inner diameter 36 mm, height 22 mm). The assembly was left to stand, and was cooled to a temperature about 20° C. lower than the melting point of the resin film.

Method for Measuring Bonding Strength

The bonding strength of the metal-resin composite member prepared as described above was measured after leaving the metal-resin composite member to stand for 48 hours at 23° C. in a test room having adjustable atmosphere temperature. The portion of bonded resin film corresponding to the 25-mm diameter hole in the metal member was removed to expose the inner hemisphere surface. FIG. 2 illustrates the Method for Measuring Bonding Strength of the metal-resin composite members. The outer periphery of the flange portion of the metal member (3) of the metal composite member (1) was mounted on the universal tester mount (10) (Autograph, by Shimadzu), without pinching the resin member. Then a metal rod (11) having a 5 mm thick circular end plate (12) and a 16 mm diameter metal semisphere (13) mounted on the end plate was inserted into the hole of the metal member, contacting and exerting pressure against the central portion of the resin member. The strength upon partial breakage of the bonding portion was then measured. Under these test conditions all samples had a uniform bonding area of 452.1 mm².

### Examples 1 to 6

Metal-resin composite members were manufactured using the metal members, resin members, resin films and silane coupling agents given in Table 1. The measurement results for bonding strength are also given in the table.

### Comparative Examples 1

Metal-resin composite members were manufactured using the metal members, resin members, resin films and silane coupling agents given in Table 1. The measurement results for bonding strength are also given in the table.

### Comparative Example 2

A metal-resin composite member was manufactured using the metal member and resin member given in Table 1, but without using any resin film. The measurement results for bonding strength are also given in the table.

### Comparative Example 3

A metal-resin composite member was manufactured using the metal member and resin member given in Table 1 and by coating the surface of the resin member with a silane coupling agent. The measurement results for bonding strength are also given in the table.

TABLE 1

| | | | | | Resin | | | |
|---|---|---|---|---|---|---|---|---|
| | | | | | film | Silane | | Bonding |
| | Fusion | Metal | Resin | Resin | thickness | coupling | Coupling agent | strength |
| | method | member | member | film | (μm) | agent | coated face | (Newtons) |
| Example 1 | Hot plate | ALD | PA-66 G33 | PA-66 | 100 | Z6011 | Both faces | 2016 |
| Example 2 | Hot plate | ALD | PA-66 G33 | PA-66 | 100 | Z6011 | One face | 1152 |
| | | | | | | | (metal member | |
| | | | | | | | side) | |
| Example 3 | Hot plate | ALD | PA-66 G33 | PA-66 | 13 | Z6011 | Both faces | 1584 |
| Example 4 | Hot plate | ALD | PA-66 G33 | TPC- | 100 | Z6011 | Both faces | 2016 |
| | | | | ET | | | | |
| Example 5 | Hot plate | ALD | PA-66 G33 | TPC- | 100 | None | — | 1140 |
| | | | | ET | | | | |
| Comparative | Hot plate | ALD | PBT G30 | PA-6 | 25 | Z6011 | Both faces | 144 |
| example 1 | | | | | | | | |
| Example 6 | Hot plate | ALD | PBT G30 | TPC- | 100 | Z6011 | Both faces | 1440 |
| | | | | ET | | | | |
| Comparative | Hot plate | ALD | PBT G30 | None | — | none | — | 0 |
| example 2 | | | | | | | | |
| Comparative | Hot plate | ALD | PBT G30 | None | — | Z6011 | Both faces | 0 |
| example 3 | | | | | | | | |

Notes:
ALD (aluminum die cast): JIS ADC-12
PA 66 G33: Zytel ® 70G33HS1L NC010
Z6011: silane coupling agent, by Dow Corning Toray Silicone Co., Ltd.
TPC-ET: DuPont Toray, Hytrel ® HTR8346 elastomer
PBT G30: Crastin ® SK605 NC010 polyester

1. A metal-resin composite member, comprising
a) a metal member having at least one surface;
b) a resin member comprising a thermoplastic resin and a dispersed inorganic material therein;
c) a thermoplastic resin film, deposed between and bonded to said resin member and said metal member, having provided on at least one face thereof an adhesion promoter, so that said at least one face of said resin film provided with said adhesion promoter contacts at least part of said at least one surface of said metal member;
wherein said thermoplastic resins of said resin member and said resin film are semicrystalline resins having a melt temperature; are selected from a resin class selected from the group consisting of polyamides, polyesters, copolyetheramide elastomers, copolyetherester elastomers, and blends thereof; and are chosen from either the same resin class or, if said thermoplastic resin of said resin member and said resin film are selected from different resin classes, said melt temperature of said resin of said resin film is equal to or lower than that of said resin of said resin member.

2. The composite member of claim 1 having a bonding strength between said metal member and said resin member of at least 300 Newtons as measured with a Method of Measuring Bonding Strength at room temperature with a bonding area of about 450 mm².

3. The composite member of claim 1 wherein said thermoplastic resins of said resin member and said resin film are the same.

4. The composite member of claim 1 wherein said thermoplastic resins of said resin member and said resin film are polyamides.

5. The composite member of claim 1 wherein each said at least one surface of said metal member is independently selected from the group consisting of aluminum, aluminum alloy, iron and iron alloy.

6. A method for manufacturing a metal-resin composite member, comprising the steps of:
arranging at least one surface of a metal member so as to oppose at least one surface of a resin member comprising a thermoplastic resin and a dispersed inorganic material therein;
arranging therebetween a thermoplastic resin film having provided on at least one face thereof an adhesion promoter, so that said face provided with said adhesion promoter contacts at least part of said least one surface of the metal member; and
bonding said metal member and said resin member by fusing said resin film thereto;
wherein said thermoplastic resins of said resin member and said resin film are semicrystalline resins having a melt temperature; are selected from a resin class selected from the group consisting of polyamides, polyesters, copolyetheramide elastomers, copolyetherester elastomers, and blends thereof; and are chosen from either the same resin class or, if said thermoplastic resin of said resin member and said resin film are selected from different resin classes, said melt temperature of said resin of said resin film is equal to or lower than that of said resin of said resin member.

7. The method of claim 6 wherein bonding said metal member and said resin member comprises heating said thermoplastic resin film above the melt temperature of said thermoplastic resin film.

8. The method of claim 6 wherein said thermoplastic resins of said resin member and said resin film are the same.

9. The method of claim 6 wherein said thermoplastic resins of said resin member and said resin film are polyamides.

10. The method of claim 6 wherein each said at least one surface of said metal member is independently selected from the group consisting of aluminum, aluminum alloy, iron and iron alloy.
